(19) United States
(12) Patent Application Publication
(10) Pub. No.: US 2015/0001053 A1
(43) Pub. Date: Jan. 1, 2015

(54) ON-LOAD TAP CHANGER AND ACCUMULATOR MECHANISM

(71) Applicant: Kabushiki Kaisha Toshiba, Minato-ku, Tokyo (JP)

(72) Inventors: Yasushi Miyamoto, Yokohama-shi (JP); Naoki Eguchi, Yokohama-shi (JP); Taku Ishikawa, Kawasaki-shi (JP)

(73) Assignee: Kabushiki Kaisha Toshiba, Minato-ku, Tokyo (JP)

(21) Appl. No.: 14/345,457

(22) PCT Filed: Sep. 19, 2012
(86) PCT No.: PCT/JP12/73921

§ 371 Date: Mar. 18, 2014

(30) Foreign Application Priority Data
Sep. 20, 2011 (JP) 2011-204022

(51) Int. Cl. H01H 9/00; H01H 3/46; H01H 3/40; H01H 3/42

(52) U.S. Cl. CPC H01H 9/0027; H01H 9/0044; H01H 3/42; H01H 3/46; H01H 3/40; H01H 2235/01; H01H 2235/016
USPC 200/11 J

(57) ABSTRACT

An accumulator mechanism including a forcible loading mechanism and accomplishing a space saving, and an on-load tap changer including the accumulator mechanism. The accumulator mechanism includes a spring, a winding casing slidable in a direction in which the spring is compressed, and an accumulating casing slidable in a direction in which the spring is elongated. A crank rotating in a manner linked with sliding of the accumulating casing, and that catches holding the accumulating casing and the crank until the winding casing compresses the spring, are provided in the interior defined by the winding casing and the accumulating casing. An eccentric cam is provided outside the winding casing and the accumulating casing, is linked with the winding casing from an exterior thereof through a swingable joint, and slides the winding casing through the swingable joint when rotated by the electric actuator mechanism.

### TECHNICAL FIELD

The present disclosure relates to an on-load tap changer utilized for a transformer, etc., and an accumulator mechanism that actuates a switch thereof.

### BACKGROUND ART

On-load tap changers are apparatuses that change a voltage while supplying a load current to a transformer. Such on-load tap changers open/close a vacuum valve upon rotation of a drive rod, and a switch selects a conducting contact. The necessary torque for the rotation of the drive rod is given from an accumulator mechanism.

Accumulator mechanisms rotate a drive rod by spring force (see, for example, Patent Document 1). Such accumulator mechanisms include a winding casing synchronously linked with, through an eccentric cam, a drive shaft rotated by an electric actuator mechanism, an accumulating casing linked with the winding casing through a spring, a crank synchronously linked with the accumulating casing, and a catch that holds the rotation of the crank at a loading position by accumulation of spring force.

Such accumulator mechanisms accumulate necessary spring force for a change operation by rotating the drive shaft when the catch is located in a loading position, and release the spring force to perform a change operation. However, the catch sometimes does not return to the loading position due to an increase in the load torque necessary for a change operation due to an irregular loading operation. Hence, the accumulator mechanisms are provided with a forcible loading mechanism that forcibly feeds the catch to the loading position by the rotation torque of the drive shaft.

As an example forcible loading mechanism, an eccentric cam is provided with a flange, while the accumulating casing is provided with a bearing. Together with the rotation of the eccentric cam attached to the drive shaft, the flange pushes the bearing, thereby sliding the accumulating casing. This forcible loading mechanism moves the catch to the loading position without torque by spring force.

### CITATION LIST

Patent Document 1: JP 2008-258259 A

### SUMMARY OF INVENTION

### Technical Problem

According to such an accumulator mechanism, it is necessary to dispose the eccentric cam and the drive shaft in the internal area defined by the winding casing and the accumulating casing. This is because to slide the winding casing by the eccentric cam, and to slide the accumulating casing by the flange attached to the eccentric cam. In this case, on a base where the accumulator mechanism is installed, the crank and the catch are disposed in the lower layer, while the eccentric cam and the drive shaft are disposed in the upper layer, and the respective members are stacked together. Accordingly, this results in an increase in the thickness of the accumulator mechanism.

Recently, a demand for conserving the space of the on-load tap changer becomes high. Accordingly, it becomes necessary to lay out the respective mechanisms using the internal dead space while optimizing the height of the whole on-load tap changer and the volume thereof.

In addition, according to a vacuum valve type in which an electrode in a vacuum container is pulled and pushed from the exterior to open and close the electrode, it is general that multiple vacuum valves individually open and close the electrode through one change operation, and thus a relatively large fluctuation in load is caused. Therefore, in a case in which a phenomenon similar to a collision is inherent, it is necessary to take an irregular peak load into consideration. Hence, a forcible loading mechanism is important to suppress a changing failure. The forcible loading mechanism surely adjusts the position of the catch and that of the crank to the standby position in a reverse operation when the accumulator energy is remarkably lost through an operation

The present disclosure has been proposed in order to address the above-explained technical problems, and it is an objective of the present disclosure to provide an accumulator mechanism that has a forcible loading mechanism but saves a space, and an on-load tap changer that includes the accumulator mechanism.

### Solution to Problem

In order to accomplish the above objective, an accumulator mechanism according to the present disclosure is included in an on-load tap changer, and performs a changing operation on a shutoff mechanism upon reception of drive force from an electric actuator mechanism. The accumulator mechanism includes the following features:

(1) a spring;

(2) a winding casing that abuts one end of the spring, and is slidable in a direction in which the spring is compressed;

(3) an accumulating casing that abuts the other end of the spring and is slidable in a direction in which the spring is elongated;

(4) a crank that abuts the accumulating casing, and rotates in a manner linked with sliding of the accumulating casing;

(5) a drive rod that is provided in a manner coaxial with the crank, and transmits rotational force to the shutoff mechanism;

(6) a catch that holds the accumulating casing and the crank until the winding casing compresses the spring;

(7) an eccentric cam that is provided outside an area where the spring, the winding casing, the accumulating casing, and the catch are retained, is linked with the winding casing from an exterior thereof through a swingable joint, and slides the winding casing through the swingable joint when rotated by the electric actuator mechanism; and

(8) a forcible loading mechanism that directly rotates the crank together with a rotating operation of the eccentric cam.

In addition, an on-load tap changer according to the present disclosure includes an accumulator mechanism, an electric actuator mechanism that actuates the accumulator mechanism, and a shutoff mechanism that is changed by the accumulator mechanism, in which the accumulator mechanism includes the following features:

(1) a spring;

(2) a winding casing that abuts one end of the spring, and is slidable in a direction in which the spring is compressed;

(3) an accumulating casing that abuts the other end of the spring and is slidable in a direction in which the spring is elongated;

(4) a crank that abuts the accumulating casing, and rotates in a manner linked with sliding of the accumulating casing;

(5) a drive rod that is provided in a manner coaxial with the crank, and transmits rotational force to the shutoff mechanism;

(6) a catch that holds the accumulating casing and the crank until the winding casing compresses the spring;

(7) an eccentric cam that is provided outside an area where the spring, the winding casing, the accumulating casing, and the catch are retained, is linked with the winding casing from an exterior thereof through a swingable joint, and slides the winding casing through the swingable joint when rotated by the electric actuator mechanism; and

(8) a forcible loading mechanism that directly rotates the crank together with a rotating operation of the eccentric cam.

### BRIEF DESCRIPTION OF DRAWINGS

FIG. 1 is a perspective view illustrating an example on-load tap changer according to a present disclosure;

FIGS. 2A and 2B are each a perspective view illustrating a structure of an accumulator mechanism according to the present disclosure;

FIG. 3 is an exploded view illustrating an accumulating structure of the accumulator mechanism according to the present disclosure;

FIG. 4 is an exploded view illustrating a forcible loading mechanism of the accumulator mechanism according to the present disclosure;

FIG. 5 is a diagram illustrating a first condition of the accumulator mechanism when in use according to the present disclosure;

FIG. 6 is a diagram illustrating a second condition of the accumulator mechanism when in use according to the present disclosure;

FIG. 7 is a diagram illustrating a third condition of the accumulator mechanism when in use according to the present disclosure; and

FIG. 8 is a diagram illustrating a last condition of the accumulator mechanism according to the present disclosure.

### DESCRIPTION OF EMBODIMENTS

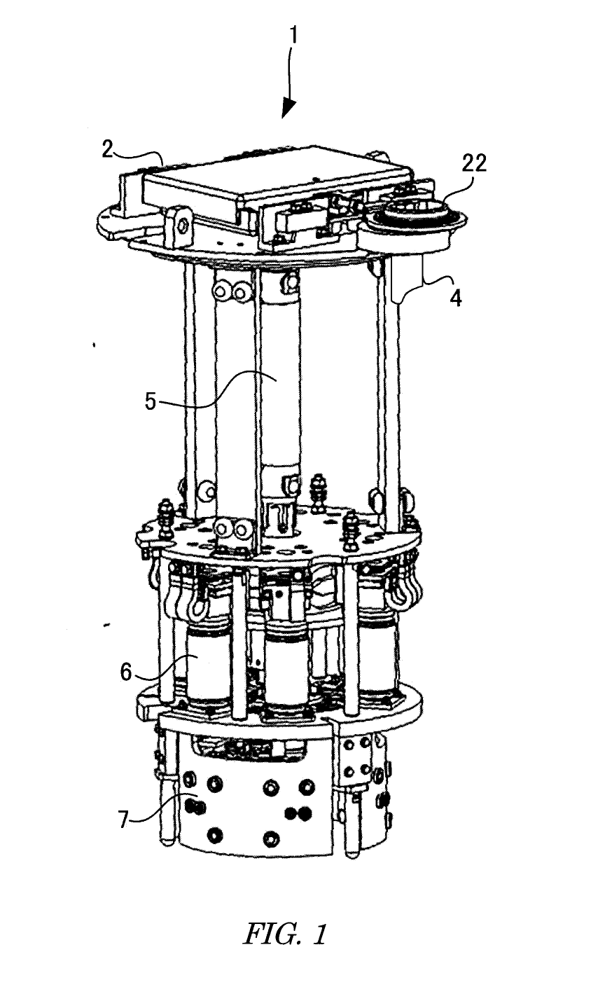

An on-load tap changer and an accumulator mechanism thereof according to the present disclosure will be explained below in detail with reference to FIGS. 1 to 8.

[Structure]

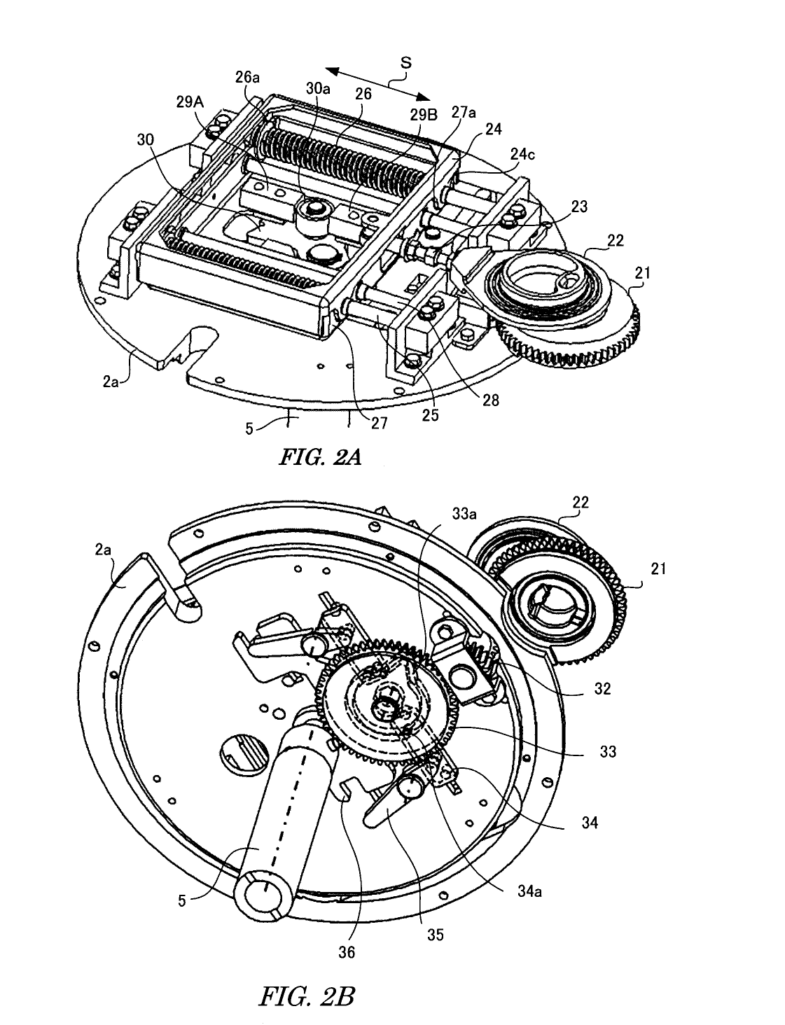

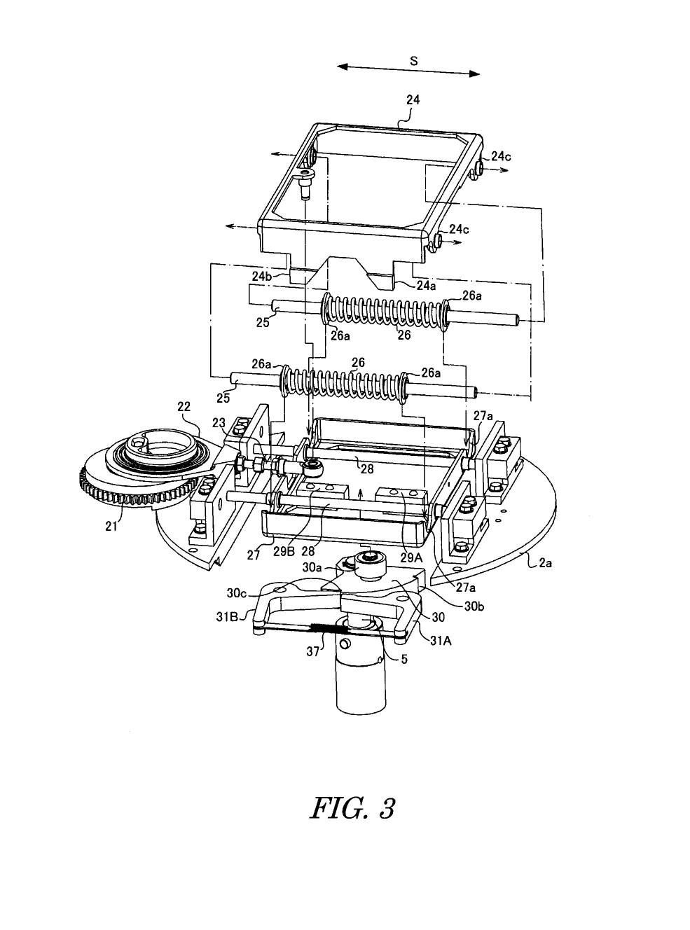

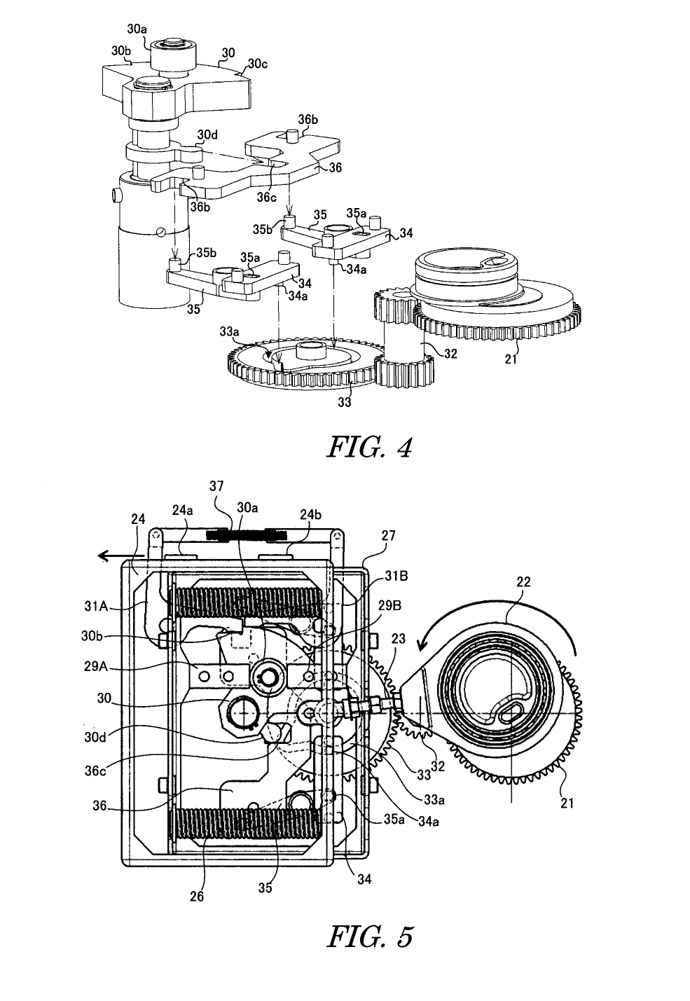

First, an on-load tap changer and an accumulator mechanism thereof according to the present disclosure will be explained in detail with reference to FIGS. 1 to 4. FIG. 1 is a perspective view illustrating an example on-load tap changer according to the present disclosure. FIGS. 2A and 2B are perspective views illustrating the structure of an accumulator mechanism 2, and FIG. 2A is a diagram as viewed from the top, while FIG. 2B is a diagram as viewed from the bottom. FIG. 3 is an exploded diagram illustrating the accumulator mechanism 2. FIG. 4 is an exploded view illustrating a forcible loading mechanism.

As illustrated in FIG. 1, an on-load tap changer 1 is an apparatus that changes a voltage while applying a load current to a transformer, and includes the accumulator mechanism 2, a drive shaft 4, a drive rod 5, vacuum valves 6, and a switch 7.

The drive shaft 4 is rotated by an unillustrated electric actuator mechanism. The drive shaft 4 is fastened with an eccentric cam 22 of the accumulator mechanism 2, and the eccentric cam 22 converts the rotational force of the drive shaft 4 into a linear motion, and transmits the linear motion to the accumulator mechanism 2. The accumulator mechanism 2 accumulates or releases coil springs 26 (see FIG. 2A) using force received from the eccentric cam 22. In addition, the accumulator mechanism 2 includes a crank 30 (see FIG. 2A) fastened to the drive rod 5, and rotates the drive rod 5 by releasing the coil springs 26. The vacuum valves 6 are opened or closed by the rotation of the drive rod 5, and the switch 7 selects the conducting contact by the rotation of the drive rod 5.

A further detailed explanation will be given of the accumulator mechanism 2 of the on-load tap changer 1. As illustrated in FIGS. 2A, 2B and 3, a tabular base 2a is provided with a winding casing 24 and an accumulating casing 27. The winding casing 24 and the accumulating casing 27 are each a rectangular frame. The elongation direction of the side end of the winding casing 24 and that of the side end of the accumulating casing 27 are consistent, but the winding case 24 is slightly larger than the accumulating casing 27, and is disposed on the accumulating casing 27.

The base 2a is provided with two shafts 25 in parallel with each other. Those shafts 25 are orthogonal to a pair of two subtenses of the winding casing 24. The winding casing 24 has flanges 24C which are provided at locations where the shafts 25 and the frame intersect, and through which the respective shafts 25 pass.

In addition, the base 2a is further provided with two shafts 28 in parallel with the shafts 25. The shafts 28 are orthogonal to a pair of two subtenses of the accumulating casing 27. The frame of the accumulating casing 27 has a larger diameter than the shaft 28, and the shafts 28 pass through the frame of this accumulating casing 27.

That is, the winding casing 24 is axially supported by the shafts 25 in a slidable manner, while the accumulating casing 27 is axially supported by the shafts 28 in a slidable manner. A sliding direction S of the winding casing 24 and the accumulating casing 27 is a direction along the shafts 25, 28.

In the frame of the accumulating casing 27, a part corresponding to the flange 24c of the winding casing 24 has a bored recess 27a one slightly larger than the flange 24c, and thus the sliding of the winding casing 24 is not interrupted by the accumulating casing 27.

The coil springs 26 are attached along the sliding direction S in the internal area defined by the winding casing 24 and the accumulating casing 27. The coil springs 26 are supported by the respective shafts 25, and the shaft 25 passes through the interior of the coil spring 26.

The natural length of the coil spring 26 is substantially same as the width of the winding casing 24 and that of the accumulating casing 27. Flanges 26a slightly larger than the bored recesses 27a are provided at both ends of the coil spring 26. Hence, when the winding casing 24 and the accumulating casing 27 are located at the same position, both ends of the coil spring 26 abut the frame of the winding casing 24 and that of the accumulating casing 27.

Still further, the crank 30 is provided on the base 2a in the internal area of the accumulating casing 27. The crank 30 has a roller 30a provided at a location apart from a rotation axis in a protruding manner. The roller 30a protrudes from the bottom of the accumulating casing 27 to the internal space. Conversely, a block 29A and a block 29B that hold the roller 30a in the sliding direction S are fastened to the bottom of the accumulating casing 27. Hence, the accumulating casing 27 and the crank 30 operate in a linked manner. In addition, the drive rod 5 passing all the way through the base 2a is fastened to the rotation axis of the crank 30, and thus the drive rod 5 rotates together with the crank 30.

The crank 30 is in a sector shape, a corresponding part of the central angle of the sector serves as a rotation shaft, and the roller 30a is attached to the sector face. In the crank 30, the center area including the center of the arc is slightly extended in the radial direction in comparison with both ends of the arc. That is, notches 30b and 30c are formed at a boundary between the center area and both ends, and the notches 30b and 30c have raised portions raised from the end of the crank 30 to the center of the arc.

Provided on the base 2a are a catch 31A to be engaged with the notch 30b and a catch 31B to be engaged with the notch 30c. The catch 31A and the catch 31B are disposed in a line-symmetric manner relative to a line intersecting the center of the moving trajectory of the arc part of the crank 30a and the rotation axis. The catch 31A is formed in a substantially L shape, while the catch 31B is formed in a substantially reversed L shape. The respective one arms of the catch 31A and the catch 31B have respective tips facing with each other, another arm of the catch 31A extends toward the notch 30b of the crank 30, and the another arm of the catch 31B extends toward the notch 30c of the crank 30. Respective another arms of the catch 31A and the catch 31B extending substantially in parallel with each other are linked through an extension spring 37.

The catch 31A and the catch 31B have respective rotation shafts at respective bent portions, and thus swingable. The winding casing 24 is provided with a release hook 24a and a release hook 24b that can internally abut the arms of the catch 31A and the catch 31B, and are provided at a side edge orthogonal to the arms of the catch 31A and the catch 31B extending substantially in parallel with each other.

The release hook 24a flips up the catch 31A around the rotation axis when the winding casing 24 slides in the direction toward the catch 31A, and releases the engagement between the catch 31A and the notch 30b of the crank 30. The release hook 24b flips up the catch 31B around the rotation axis when the winding casing 24 slides in the direction toward the catch 31B, and releases the engagement between the catch 31B and the notch 30b of the crank 30.

In such an accumulator mechanism 2, the eccentric cam 22 that causes the winding casing 24 to slide is provided outside the internal area defined by the winding casing 24 and the accumulating casing 27. The eccentric cam 22 is fastened to the drive shaft 4, and rotates together with the rotation of the drive shaft 4. The eccentric cam 22 is formed in an external shape having a cam robe protruding from a part of the circumference coaxial with the rotation shaft fastened to the drive shaft 4. More specifically, the eccentric cam 22 is formed by a disk and a block including the cam robe. Moreover, the drive shaft 4 is fastened to the center of the disk, and the block is fastened to the surface of the disk, and, the cam robe portion protrudes in the radial direction from the outer circumference of the disk.

The eccentric cam 22 and the winding casing 24 are linked through a swingable joint 23 with a fixed length. The one end of the swingable joint 23 is linked with the apex of the cam robe, and is swingable in parallel with the rotation plane of the eccentric cam 22. In addition, another end of the swingable joint 23 is linked with a side edge of the winding casing 24 orthogonal to the sliding direction S, and is swingable in parallel with a plane including the winding casing 24.

Next, an explanation will be given of the structure of the forcible loading mechanism when such eccentric cam 22 and drive shaft 4 are provided outside the internal area defined by the winding casing 24 and the accumulating casing 27 with reference to FIGS. 2 and 4. First, the eccentric cam 22 has a gear 21. The gear 21 is the disk part of the eccentric cam 22, and is a spur gear or a helical gear having a large number of gear teeth provided around the outer circumference thereof.

The gear 21 is meshed with an intermediate gear 32 with a parallel shaft with the gear 21. The intermediate gear 32 has a pair of spur gears or helical gears formed at both ends of the shaft in a fastened manner, the one gear is located on the upper face of the base 2a to mesh with the gear 21, and another gear is located below the base 2a.

In the intermediate gear 32, the gear located below the base 2a is meshed with a gear 33 having a parallel shaft with the gear 21 and the intermediate gear 32. This gear 33 is a spur gear or a helical gear, and has the same number of gear teeth as that of the gear 21 of the eccentric cam 22. The rotation axes of the gear 21, the intermediate gear 32, and the gear 33 are disposed along a straight line.

The gear 33 has a cam mechanism, and is engaged with a slider 34 serving as a cam follower. That is, the gear 33 has a cam groove 33a provided in the surface thereof. This cam groove 33a is formed around the rotation axis of the gear 33 in a coaxial manner, and a part of the passage is a cam robe continuously becoming distant from the rotation axis.

The slider 34 is tabular member, and has a pin 34a provided at one end. The pin 34a protrudes from the surface of the slider 34, and is fitted in the cam groove 33 in a slidable manner. This slider 34 has the pin 34a sliding in the cam groove 33 together with the rotation of the gear 33, and when the pin 34a reaches the cam robe, the slider slides so as to be apart from the rotation axis of the gear 33. The sliding direction of the slider 34 is a direction apart from the crank 30.

The position of the cam groove 33a and the height of the cam robe are set in such a way that, when the pin 34a of the slider 34 is located at the apex of the cam robe of the cam groove 33a, the swingable joint 23 and the winding casing 24 become orthogonal, and the pushing level of the coil springs 26 by the winding casing 24 becomes the maximum.

The slider 34 is linked with a lever 35 in a manner rotatable around a pin 35a. The pin 35a is located at one end of the lever 35 apart from the rotation axis of the lever 35. A push pin 35b is provided at another end of the lever 35. Since the linked portion of the lever 35 with the slider 34 rotates in a direction apart from the crank 30 along with the sliding operation of the slider 34, the push pin 35b rotates in a direction becoming close to the crank 30.

The push pin 35b of the lever 35 abuts one end of a slider 36. The slider 36 is disposed at the crank-30 side beyond the push pin 35b of the lever 35, and extends along the one tangent line outwardly relative to the crank 30.

The slider 36 has an engaged portion 36b formed in an end at the push-pin-35b side. The engaged portion 36b is formed in a U-shape having an open end facing with the push pin 35b, and the opening is hollowed toward the lengthwise direction of the slider 36. This engaged portion 36b abuts the push pin 35b at the rearmost part of the opening. Accordingly, when the lever 35 rotates, and the push pin 35b rotates toward the crank 30, the slider 36 moves the side of the crank 30.

This slider 36 is a member that moves to rotate the crank 30. That is, the slider 36 has a U-shaped engaged portion 36c opened toward the crank 30. Conversely, the crank 30 has a support holder 30d that extends up to the interior of the opening of the engaged portion 36c.

The support holder 30d is fitted with the drive shaft 5 that is the rotation shaft of the crank 30, and is a protrusion protruding from the crank 30 so as to be orthogonal to the drive shaft 5. The support holder is retained in the opening of the engaged portion 36c, and abuts both sides of the engaged portion 36c. Hence, when the slider 36 moves, the support holder 30d also moves, and the traveling force of the support holder 30d is converted into rotational force, and thus the crank 30 rotates. The slider 34, the lever 35, and the slider 36 are disposed at positions in such a way that the rotating direction of the crank 30 is consistent with the sliding direction S of the accumulating casing 27.

According to such a forcible loading mechanism, the pair of sliders 34, the pair of levers 35, and the pair of sliders 36 are provided in a linearly symmetrical manner relative to a line interconnecting both rotation axes of the crank 30 and the gear 21 of the eccentric cam 22.

In addition, the height of the cam robe of the cam groove 33a is set in such a way that, when the crank 30 is rotated to the maximum angle, the accumulating casing 27 slides over the winding casing 24, and the coil springs 26 are slightly elongated than a natural length. Still further, the height of the cam robe of the cam groove 33a and the ranges of the notches 30b, 30c of the crank 30 are set in such a way that, when the crank 30 is rotated to the maximum angle, the catches 31A, 31B are trapped in the notches 30b, 30c of the crank 30, and the respective raised portions of the notches 30b, 30c are distant from the tip of the crank 30 by a predetermined distance.

[Operation]

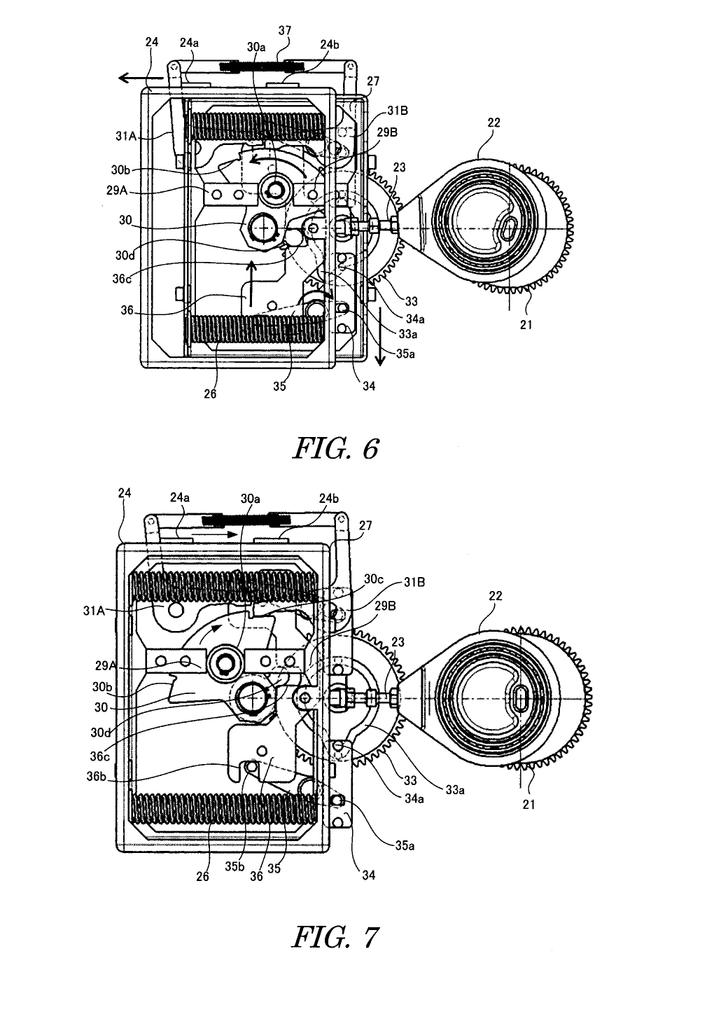

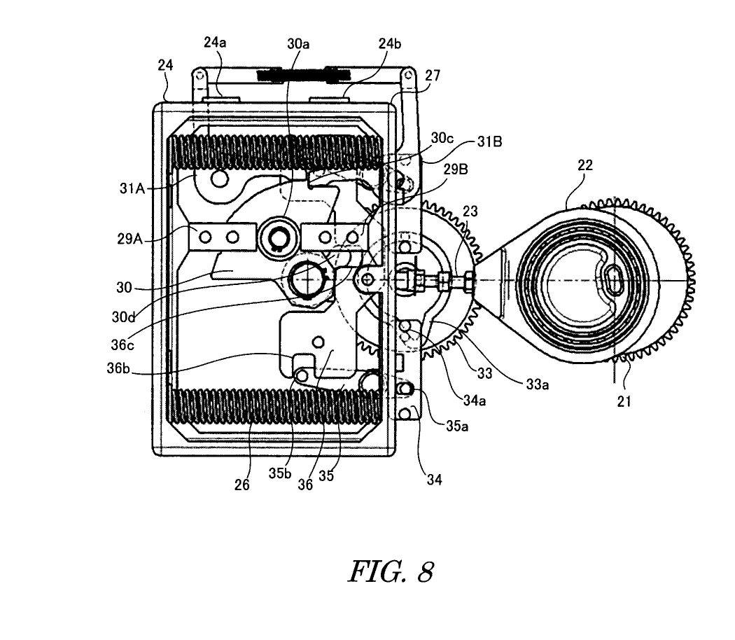

The operation of the above-explained accumulator mechanism 2 will be explained in detail with reference to FIGS. 5 to 8. FIGS. 5 to 8 illustrate the operation of the accumulator mechanism 2 in a time-series order. FIG. 5 illustrates a first condition of the accumulator mechanism 2 when in use, and FIG. 6 illustrates a second condition. FIG. 7 illustrates a third condition, and FIG. 8 illustrates a last condition of the accumulator mechanism 2 when in use.

First, as illustrated in FIG. 5, when an electric actuator mechanism is driven to rotate the drive shaft 4, the eccentric cam 22 fastened to the drive shaft 4 also rotates. Upon rotation of the eccentric cam 22, the cam robe of the eccentric cam 22 becomes close to the winding casing 24. When the cam robe becomes close to the winding casing 24, the winding casing 24 has the swingable joint 23 serving as a spur, thus sliding in a direction becoming distant from the eccentric cam 22 along the shafts 25.

When the winding casing 24 starts sliding, the flanges 24c of the winding casing 24 moves to the interior of the frame of the accumulating casing 27. Simultaneously, respective one ends of the coil springs 26 are pushed in the interior of the accumulator casing 27 upon abutment of the flanges 26a with the flanges 24c.

Conversely, the accumulating casing 27 has the catch 31A abutting the notch 30b to hold the crank 30. Accordingly, the roller 30a cannot be moved by the block 29B, thus the accumulating casing is unmovable. Hence, respective another ends of the coil springs 26 are unmovable while abutting the side edge of the accumulating casing 27. That is, the coil springs 26 are compressed between the winding casing 24 and the accumulating casing 27, and are in an accumulated condition.

Next, as illustrated in FIG. 6, when the electric actuator mechanism is driven, the winding casing 24 further slides. In this case, the release hook 24a pushes the arm of the catch 31A from the internal side to the external side, and the catch 31A is flipped up in a direction in which the arm of the catch 31A abutting the notch 30b becomes distant from the notch 30b.

When the catch 31A is flipped up, the engagement relationship between the catch 31A and the crank 30 is released, and thus the crank 30 becomes able to rotate. In this case, the coil springs 26 compressed until the crank 30 becomes able to rotate start releasing compression. That is, the coil springs 26 expand, and slide the accumulator casing 27 along the shafts 28 in the direction in which the winding casing 24 has moved.

When the accumulating casing 27 slides, the block 29B pushes and moves the roller 30a. Next, when the roller 30a moves in the circumferential direction of the crank 30, the crank 30 starts rotating. Upon rotation of the crank 30, the drive rod 5 starts rotating.

Still further, according to this forcible loading mechanism, while the forces of the coil springs 26 are accumulated and released, the following operations are performed. That is, the gear 21 rotates together with the rotation of the eccentric cam 22, and the gear 33 meshed therewith through the intermediate gear 32 also rotates. Upon rotation of the gear 33, the pin 34a of the slider 34 slides in the cam groove 33a.

The pin 34a of the slider 34 reaches the bottom part of the cam robe of the cam groove 33a when the release hook 24a flips up the catch 31A and the engagement between the catch 31A and the crank 30 is released. Next, when the eccentric cam 22 further rotates, the pin 34a of the slider 34 slides in the cam groove 33a toward the apex of the cam robe.

When the pin 34a of the slider 34 slides in the cam groove 33a toward the apex of the cam robe, the slider 34 is pulled by the pin 34a, and moves in a direction apart from the crank 30. In this case, the lever 35 linked with the slider 34 starts rotating so as to move the push pin 35b in the direction toward the crank 30.

When the push pin 35b moves in the direction toward the crank 30, the push pin 35b has the engaged portion 36b abutting the slider 36, and moves the slider 36 in the tangent-line direction of the crank 30. When the slider 36 starts moving, the slider 36 causes the support holder 30d to rotate using the engaged portion 36c. When the support holder 30d rotates, the crank 30 fastened with the support holder 30d starts rotating in the sliding direction S of the accumulating casing 27.

Next, as illustrated in FIG. 7, when the eccentric cam 22 further rotates, and the pin 34a of the slider 36 reaches the apex position of the cam robe of the cam groove 33a, the sliding level of the slider 36 becomes the maximum, and thus the crank 30 is forcibly rotated to the maximum angle regardless of the compression releasing operation by the coil springs 26. When the crank 30 is rotated to the maximum angle through the actuation of the forcible loading mechanism, the catch 31B is trapped in the notch 30c of the crank 30, and becomes distant from the raised portion of the notch 30c by a predetermined distance.

In addition, when the pin 34a of the slider 34 reaches the apex of the cam robe of the cam groove 33a, the accumulating casing 27 slides over the overlapping position with the winding casing 24, and the coil springs 26 are compressed between the winding casing 24 and the accumulating casing 27, and thus it becomes an accumulating condition.

Still further, as illustrated in FIG. 8, when the eccentric cam 22 rotates to the end position, the pin 34a of the slider 34 passes through the apex of the cam robe of the cam groove 33a. At this time, the slider 34 slightly returns in the reverse direction, and the push pin 35b of the lever 35 slightly becomes distant from the engaged portion 36b of the slider 36. In this condition, no action of the forcible loading mechanism is applied to the crank 30.

Accordingly, due to the elongation action of the compressed coil springs 26, the accumulating casing 27 that has slid over the overlapping position with the winding casing 24 returns to the overlapping position with the winding casing 24. Due to this return operation of the accumulating casing 27, the block 29A pushes back the roller 30a, and the crank 30 rotates in the reverse direction. Upon the reverse rotation of the crank 30, the catch 31B abuts the raised portion of the notch 30c, and thus the crank 30 is prevented from rotating by the catch 31B.

With the crank 30 being prevented from rotating by the catch 31B, the inverse operation to the above-explained operation is performed through the reverse rotation of the eccentric cam 22, and the other slider 34, lever 35, and slider 36 disposed symmetrically perform a forcible loading operation.

### Advantageous Effects

As explained above, according to the accumulator mechanism 2 of the present disclosure, the eccentric cam 22 is provided outside the internal area, and is linked with the winding casing 24 through the swingable joint 23 from the exterior. This eccentric cam 22 is rotated by the electric actuator mechanism, thereby sliding the winding casing 24 through the swingable joint 23. Accordingly, it is unnecessary for the eccentric cam 22 to overlap with the crank 30, the catch 31A, and the catch 31B, making it possible to reduce the thickness of the accumulator mechanism 2. Therefore, space saving for the on-load tap changer 1 can be accomplished.

The forcible loading mechanism includes the gear 21 having gear teeth provided on a circle coaxial with the rotation trajectory of the eccentric cam 22, and the sliders 36 that linearly move in the rotation tangent-line direction of the crank 30 by the rotation of the gear 21, and are linked with the crank 30 through the support holder 30d.

As a mechanism that converts the rotational force of the gear 21 into a linear motion of the sliders 36, the gear 33 is disposed at the back side of the accumulating casing 27, and the rotation of the gear 21 is transmitted to this gear 33. The gear 33 has the cam groove 33a provided therein. This cam groove 33a is formed around the rotation axis of the gear 33, and has the cam robe having a partial area continuously distant from the rotation axis. In addition, the slider 34 having the pin 35a that slides in the cam groove 33a is provided, and is linearly moved together with the rotation of the gear 33. This slider 34 is linked with the one end of the lever 35 to let the lever 35 to swing together with the linear motion of the slider 34, and to push the slider 36 through another end of the lever 35, thereby causing the slider 36 to perform a linear motion.

Accordingly, the forcible loading mechanism can be provided using a dead space that is the back side of the accumulating casing 27. Hence, even if the forcible loading mechanism is disposed, the height of the on-load tap changer 1 and the volume thereof do not increase.

Moreover, this forcible loading mechanism further includes the intermediate gear 32 meshed with the gear 21 and the gear 33, the number of gear teeth of the gear 21 is the same as that of the gear 33, and the respective axes of the gear 21, the intermediate gear 32, and the gear 33 are disposed on the same straight line. Accordingly, the loading direction can be uniformly divided in the 180-degree direction without deteriorating the reversibility of the operation due to the rotation direction of the switch 7.

### Other Embodiments

The specific example of the present disclosure was explained in the present specification, but the specific example is merely presented as an example, and is not intended to limit the scope and spirit of the present disclosure. The present disclosure can be carried out in other various forms, and permits various omissions, replacements, and modifications without departing from the scope and spirit of the present disclosure. Such forms and modifications thereof are within the scope and spirit of the present disclosure, and are also within the equivalent range of the subject matter as recited in appended claims.

### REFERENCE SIGNS LIST

1 On-load tap changer
2 Accumulator mechanism
2a Base
21 Gear
22 Eccentric cam
23 Swingable joint
24 Winding casing
24a Release hook
24b Release hook
24c Flange
25 Shaft
26 Spring
26a Flange
27 Accumulating casing
27a Bored recess
28 Shaft
29A Block
29B Block
30 Crank
30a Roller
30b Notch
30c Notch
30d Support holder
31A Catch
31B Catch
32 Intermediate gear
33 Gear
33a Cam groove
34 Slider
34a Pin
35 Lever
35a Pin
35b Push pin
36 Slider
36b Engaged portion
36c Engaged portion
37 Extension spring
4 Drive shaft
5 Drive rod
6 Vacuum valve
7 Switch

1. An accumulator mechanism that is included in an on-load tap changer, and performs a changing operation on a shutoff mechanism upon reception of drive force from an electric actuator mechanism, the accumulator mechanism comprising:
a spring;
a winding casing that abuts one end of the spring, and is slidable in a direction in which the spring is compressed;
an accumulating casing that abuts an other end of the spring and is slidable in a direction in which the spring is elongated;
a crank that abuts the accumulating casing, and rotates in a manner linked with sliding of the accumulating casing;
a drive rod that is provided in a manner coaxial with the crank, and transmits rotational force to the shutoff mechanism;
a catch that holds the accumulating casing and the crank until the winding casing compresses the spring;
an eccentric cam that is provided outside an area where the spring, the winding casing, the accumulating casing, and the catch are retained, is linked with the winding casing from an exterior thereof through a swingable joint, and slides the winding casing through the swingable joint when rotated by the electric actuator mechanism; and
a forcible loading mechanism that directly rotates the crank together with a rotating operation of the eccentric cam.

2. The accumulator mechanism according to claim 1, wherein the forcible loading mechanism comprises:
a gear having gear teeth provided on a circle coaxial with a rotation trajectory of the eccentric cam; and
a slider that linearly moves in a rotation tangent-line direction of the crank upon rotation of the gear, and is linked with the crank.

3. The accumulator mechanism according to claim 2, wherein the forcible loading mechanism further comprises:
a second gear that is disposed at a back side of the accumulating casing, and is driven upon receiving a rotation of the gear;
a cam groove that is formed around a rotation axis of the second gear, and includes a cam robe having a partial area continuously distant from the rotation axis;
a second slider that includes a pin sliding in the cam groove, and linearly moves along a rotation of the second gear; and
a lever that has one end linked with the second slider, has an other end linked with the slider, swings together with a linear motion of the second slider to linearly move the slider.

4. The accumulator mechanism according to claim 3, wherein:
the forcible loading mechanism further comprises a third gear meshed with the gear and the second gear;
a number of gear teeth of the gear is consistent with a number of gear teeth of the second gear; and
respective axes of the gear, the third gear, and the second gear are disposed along a same straight line.

5. An on-load tap changer that comprises an accumulator mechanism, an electric actuator mechanism that actuates the accumulator mechanism, and a shutoff mechanism that is changed by the accumulator mechanism,
wherein the accumulator mechanism comprises:
a spring;
a winding casing that abuts one end of the spring, and is slidable in a direction in which the spring is compressed;
an accumulating casing that abuts an other end of the spring and is slidable in a direction in which the spring is elongated;
a crank that abuts the accumulating casing, and rotates in a manner linked with sliding of the accumulating casing;
a drive rod that is provided in a manner coaxial with the crank, and transmits rotational force to the shutoff mechanism;
a catch that holds the accumulating casing and the crank until the winding casing compresses the spring;
an eccentric cam that is provided outside an area where the spring, the winding casing, the accumulating casing, and the catch are retained, is linked with the winding casing from an exterior thereof through a swingable joint, and slides the winding casing through the swingable joint when rotated by the electric actuator mechanism; and
a forcible loading mechanism that directly rotates the crank together with a rotating operation of the eccentric cam.

6. The on-load tap changer according to claim 5, wherein the forcible loading mechanism comprises:
a gear having gear teeth provided on a circle coaxial with a rotation trajectory of the eccentric cam; and
a slider that linearly moves in a rotation tangent-line direction of the crank upon rotation of the gear, and is linked with the crank.

7. The on-load tap changer according to claim 6, wherein the forcible loading mechanism further comprises:
a second gear that is disposed at a back side of the accumulating casing, and is driven upon receiving a rotation of the gear;
a cam groove that is formed around a rotation axis of the second gear, and includes a cam robe having a partial area continuously distant from the rotation axis;
a second slider that includes a pin sliding in the cam groove, and linearly moves along a rotation of the second gear; and
a lever that has one end linked with the second slider, has an other end linked with the slider, swings together with a linear motion of the second slider to linearly move the slider.

8. The on-load tap changer according to claim 7, wherein:
the forcible loading mechanism further comprises a third gear meshed with the gear and the second gear;
a number of gear teeth of the gear is consistent with a number of gear teeth of the second gear; and
respective axes of the gear, the third gear, and the second gear are disposed along a same straight line.
